(19) United States
(12) Patent Application Publication
(10) Pub. No.: US 2003/0093440 A1
(43) Pub. Date: May 15, 2003

(54) Replica update vectors

(76) Inventors: John Merrells, Mountain View, CA (US); Olga Natkovich, Sunnyvale, CA (US); Gordon Good, Mountain View, CA (US); Pinaki Shah, Sunnyvale, CA (US); Mark C. Smith, Saline, MI (US)

Correspondence Address: ROSENTHAL & OSHA L.L.P., 1221 MCKINNEY AVENUE, SUITE 2800, HOUSTON, TX, 77010, US

(21) Appl. No.: 09/993,937

(22) Filed: Nov. 6, 2001

(51) Int. Cl. G06F 12/00

(52) U.S. Cl. 707/201

(57) ABSTRACT

A directory server including a supplier server, a consumer server in communication with the supplier server, a plurality of pluggable services that manage replication of data contained within the directory server from the supplier server to the consumer server; and a replica update vector used to determine a minimal set of updates necessary to synchronize the consumer server with respect to the supplier server. Replication of data is managed using the replica update vector.

### BACKGROUND OF INVENTION

The most fundamental program resident on any computer is the operating system (OS). Various operating systems exist in the market place, including Solaris™ from Sun Microsystems Inc., Palo Alto, Calif. (Sun Microsystems), MacOS from Apple Computer, Inc., Cupertino, Calif., Windows® 95/98 and Windows NT®, from Microsoft Corporation, Redmond, Wash., UNIX, and Linux. The combination of an OS and its underlying hardware is referred to herein as a “traditional platform.” Prior to the popularity of the Internet, software developers wrote programs specifically designed for individual traditional platforms with a single set of system calls and, later, application program interfaces (APIs). Thus, a program written for one platform could not be run on another. However, the advent of the Internet made cross-platform compatibility a necessity and a broader definition of a platform has emerged. Today, the original definition of a traditional platform (OS/hardware) dwells at the lower layers of what is commonly termed a “stack,” referring to the successive layers of software required to operate in the environment presented by the Internet and World Wide Web.

Effective programming at the application level requires the platform concept to be extended all the way up the stack, including all the new elements introduced by the Internet. Such an extension allows application programmers to operate in a stable, consistent environment.

iPlanet™ E-commerce Solutions, a Sun Microsystems|Netscape Alliance, has developed a net-enabling platform shown in FIG. 1 called the Internet Service Deployment Platform (ISDP) (28). ISDP (28) gives businesses a very broad, evolving, and standards-based foundation upon which to build an e-enabled solution.

A core component of the ISDP (28) is iPlanet™ Directory Server (80), a Lightweight Directory Access Protocol (LDAP)-based solution that can handle more than 5,000 queries per second. iPlanet™ Directory Server (iDS) provides a centralized directory service for an intranet or extranet while integrating with existing systems. The term “directory service” refers to a collection of software, hardware, and processes that store information and make the information available to users. The directory service generally includes at least one instance of the iDS and one or more directory client program(s). Client programs can access names, phone numbers, addresses, and other data stored in the directory.

The iDS is a general-purpose directory that stores all information in a single, network-accessible repository. The iDS provides a standard protocol and application programming interface (API) to access the information contained by the iDS. The iDS provides global directory services, meaning that information is provided to a wide variety of applications. Until recently, many applications came bundled with a proprietary database. While a proprietary database can be convenient if only one application is used, multiple databases become an administrative burden if the databases manage the same information. For example, in a network that supports three different proprietary e-mail systems where each system has a proprietary directory service, if a user changes passwords in one directory, the changes are not automatically replicated in the other directories. Managing multiple instances of the same information results in increased hardware and personnel costs.

The global directory service provides a single, centralized repository of directory information that any application can access. However, giving a wide variety of applications access to the directory requires a network-based means of communicating between the numerous applications and the single directory. The iDS uses LDAP to give applications access to the global directory service.

LDAP is the Internet standard for directory lookups, just as the Simple Mail Transfer Protocol (SMTP) is the Internet standard for delivering e-mail and the Hypertext Transfer Protocol (HTTP) is the Internet standard for delivering documents. Technically, LDAP is defined as an on-the-wire bit protocol (similar to HTTP) that runs over Transmission Control Protocol/Internet Protocol (TCP/IP). LDAP creates a standard way for applications to request and manage directory information.

An LDAP-compliant directory, such as the iDS, leverages a single, master directory that owns all user, group, and access control information. The directory is hierarchical, not relational, and is optimized for reading, reliability, and scalability. This directory becomes the specialized, central repository that contains information about objects and provides user, group, and access control information to all applications on the network. For example, the directory can be used to provide information technology managers with a list of all the hardware and software assets in a widely spanning enterprise. Most importantly, a directory server provides resources that all applications can use, and aids in the integration of these applications that have previously functioned as stand-alone systems. Instead of creating an account for each user in each system the user needs to access, a single directory entry is created for the user in the LDAP directory. FIG. 2 shows a portion of a typical directory with different entries corresponding to real-world objects. The directory depicts an organization entry (90) with the attribute type of domain component (dc), an organizational unit entry (92) with the attribute type of organizational unit (ou), a server application entry (94) with the attribute type of common name (cn), and a person entry (96) with the attribute type of user ID (uid). All entries are connected by the directory.

Understanding how LDAP works starts with a discussion of an LDAP protocol. The LDAP protocol is a message-oriented protocol. The client constructs an LDAP message containing a request and sends the message to the server. The server processes the request and sends a result, or results, back to the client as a series of LDAP messages. Referring to FIG. 3, when an LDAP client (100) searches the directory for a specific entry, the client (100) constructs an LDAP search request message and sends the message to the LDAP server (102) (step 104). The LDAP server (102) retrieves the entry from the database and sends the entry to the client (100) in an LDAP message (step 106). A result code is also returned to the client (100) in a separate LDAP message (step 108).

LDAP-compliant directory servers like the iDS have nine basic protocol operations, which can be divided into three categories. The first category is interrogation operations, which include search and compare operators. These interrogation operations allow questions to be asked of the directory. The LDAP search operation is used to search the directory for entries and retrieve individual directory entries. No separate LDAP read operation exists. The second category is update operations, which include add, delete, modify, and modify distinguished name (DN), i.e., rename, operators. A DN is a unique, unambiguous name of an entry in LDAP. These update operations allow the update of information in the directory. The third category is authentication and control operations, which include bind, unbind, and abandon operators.

The bind operator allows a client to identify itself to the directory by providing an identity and authentication credentials. The DN and a set of credentials are sent by the client to the directory. The server checks whether the credentials are correct for the given DN and, if the credentials are correct, notes that the client is authenticated as long as the connection remains open or until the client re-authenticates. The unbind operation allows a client to terminate a session. When the client issues an unbind operation, the server discards any authentication information associated with the client connection, terminates any outstanding LDAP operations, and disconnects from the client, thus closing the TCP connection. The abandon operation allows a client to indicate that the result of an operation previously submitted is no longer of interest. Upon receiving an abandon request, the server terminates processing of the operation that corresponds to the message ID.

In addition to the three main groups of operations, the LDAP protocol defines a framework for adding new operations to the protocol via LDAP extended operations. Extended operations allow the protocol to be extended in an orderly manner to meet new marketplace needs as they emerge.

The basic unit of information in the LDAP directory is an entry, a collection of information about an object. Entries are composed of a set of attributes, each of which describes one particular trait of an object. Attributes are composed of an attribute type (e.g., common name (cn), surname (sn), etc.) and one or more values. FIG. 4 shows an exemplary entry (124) showing attribute types (120) and values (122). Attributes may have constraints that limit the type and length of data placed in attribute values (122). A directory schema places restrictions on the attribute types (120) that must be, or are allowed to be, contained in the entry (124).

### SUMMARY OF INVENTION

In general, in one aspect, the invention involves a directory server. The directory server comprises a supplier server, a consumer server in communication with the supplier server, a plurality of pluggable services that manage replication of data contained within the directory server from the supplier server to the consumer server, and a replica update vector used to determine minimal set of updates necessary to synchronize the consumer server with respect to the supplier server. Replication of data is managed using the replica update vector.

In general, in one aspect, the invention involves a method of updating a replica update vector. The method comprises requesting a replica update vector from a consumer server, sending the replica update vector from the consumer server to a supplier server, comparing the replicate update vector of the consumer server with the replica update vector of the supplier server, sending discrepancies of a comparison from the supplier server as an update to the replica update vector of the consumer server, if a discrepancy exists.

In general, in one aspect, the invention involves a method of updating a replica update vector. The method comprises requesting a replica update vector from a consumer server, sending the replica update vector from the consumer server to a supplier server, comparing the replica update vector of the consumer server with the replica update vector of the supplier server, sending discrepancies of a comparison from the supplier server as an update to the replica update vector of the consumer server, if a discrepancy exists, and exchanging the replica update vector at the beginning of a replication session.

In general, in one aspect, the invention involves an apparatus for updating a replica update vector. The apparatus involves means for requesting a replica update vector from a consumer server, means for sending the replica update vector from the consumer server to a supplier server, means for comparing the replica update vector of the consumer server with the replica update vector of the supplier server; and means for sending discrepancies of a comparison from the supplier server as an update to the replica update vector of the consumer server, if a discrepancy exists.

Other aspects and advantages of the invention will be apparent from the following description and the appended claims.

### BRIEF DESCRIPTION OF DRAWINGS

FIG. 1 illustrates a block diagram of iPlanet™ Internet Service Development Platform.

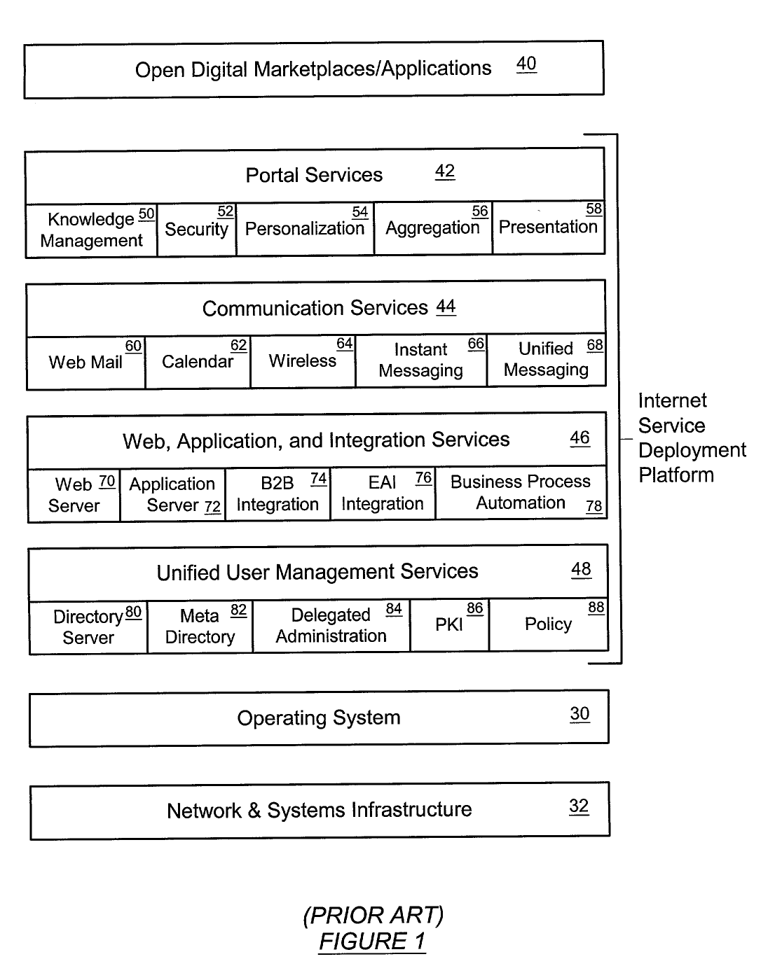

FIG. 2 illustrates part of a typical directory.

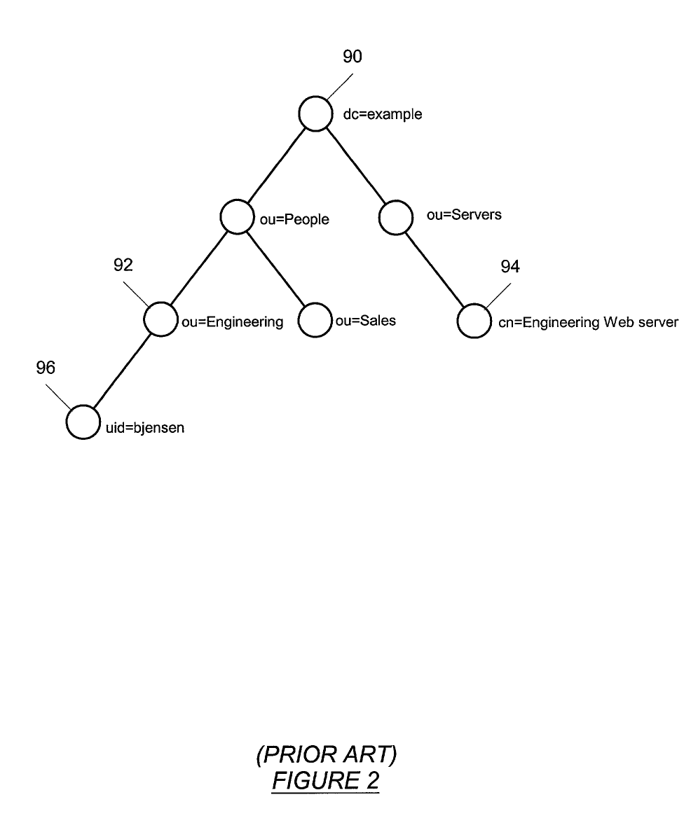

FIG. 3 illustrates the LDAP protocol used for a simple request.

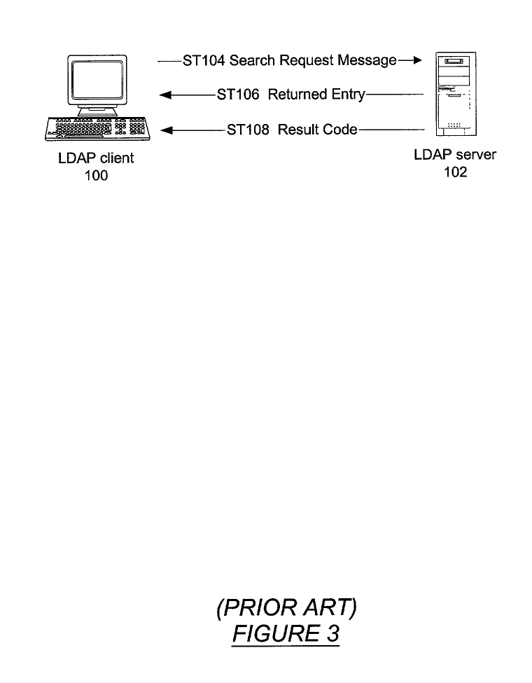

FIG. 4 illustrates a directory entry showing attribute types and values.

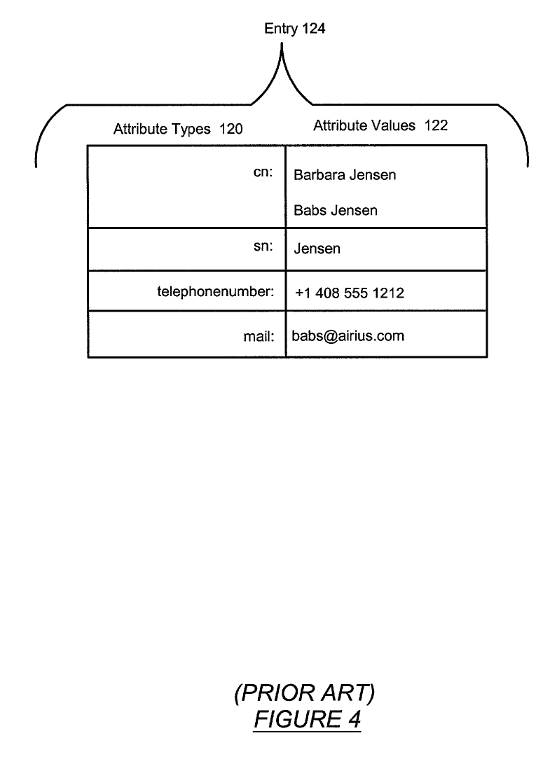

FIG. 5 illustrates a typical computer with components.

FIG. 6 illustrates block diagram of iPlanet™ Directory Server in one embodiment of the present invention.

FIG. 7 illustrates an exemplary flow process of a replication session Server in one embodiment of the present invention.

### DETAILED DESCRIPTION

Specific embodiments of the invention will now be described in detail with reference to the accompanying figures. Like elements in the various figures are denoted by like reference numerals for consistency.

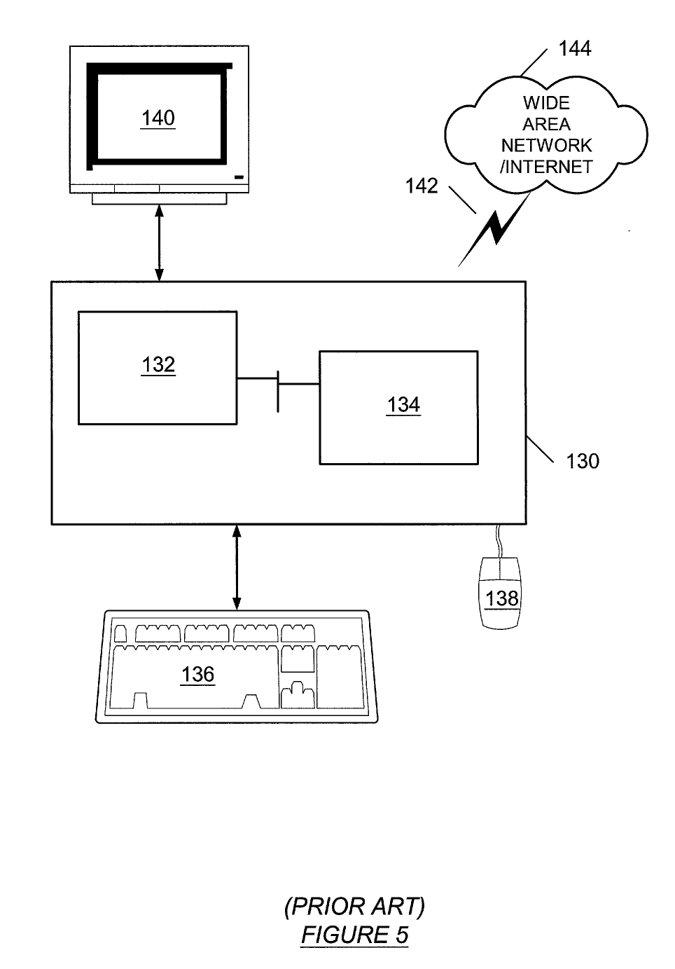

The invention described here may be implemented on virtually any type computer regardless of the traditional platform being used. For example, as shown in FIG. 5, a typical computer (130) has a processor (132), memory (134), among others. The computer (130) has associated therewith input means such as a keyboard (136) and a mouse (138), although in an accessible environment these input means may take other forms. The computer (130) is also associated with an output device such as a display (140), which also may take a different form in a given accessible environment. The computer (130) is connected via a connection means (142) to a wide area network (144), such as the Internet.

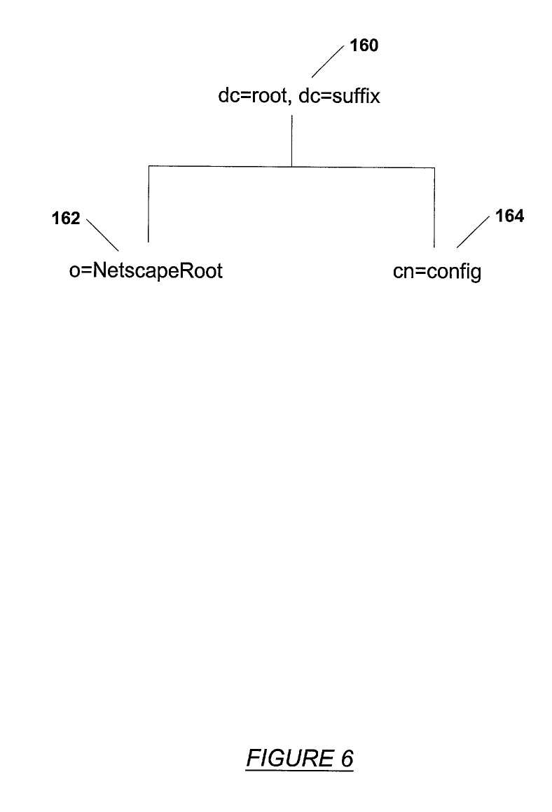

A basic directory tree, also known as directory information tree (DIT), mirrors a tree model used by most file systems, with a tree root, or first entry, appearing at the top of a hierarchy. At installation, the iDS creates a default directory tree as show in FIG. 6. The default directory tree contains a root (160) (dc=root, dc=suffix) and two entries. A first entry is o=NetscapeRoot (162). The data contained by this subtree is used by the iPlanet™ Administration Server. The iPlanet™ Administration Server handles authentication, and all actions that cannot be performed through LDAP (such as starting or stopping). A second entry is cn=config (164). This subtree contains iDS configuration information.

The initial directory tree contains one subtree reserved for the server itself and one subtree for iPlanet™ Administration Server. All the iDS typically contain the cn=config data, but only one (the first server installed) contains the o=NetscapeRoot information. The default directory can be built upon to add any data relevant to a directory installation.

The present invention involves the use of Replica Update Vectors (RUV) in a directory server. An RUV is maintained by each replica participating in multimaster replication. The RUV contains the state of a replica with respect to other replicas. The RUV is used by a multimaster replication protocol to determine the minimal set of updates to bring a consumer up to date with respect to a supplier.

In accordance with one or more embodiments of the present invention, an RUV contains a replica generation ID. A replica generation ID identifies a version of the data to which the RUV applies. If the data is reloaded, the old RUV is discarded, and a new RUV is generated. The replica generation ID is used by the multimaster replication protocol to ensure that a consumer and a supplier contain the same version of the data. Also, for each updateable replica, an RUV contains a minimum change sequence number (CSN). A minimum CSN is used by a multimaster replication protocol to update a replica that has never seen changes from a particular updateable replica. Also, an RUV contains a maximum CSN received by the local replica that was generated by a particular updateable replica. The maximum CSN determines the point in the update stream from which an update of the consumer should start. It is possible to maintain both the minimum and maximum CNS's because multimaster replication protocol guarantees that changes generated on a particular updateable replica are received by a consumer in CSN order. An RUV also contains a partial URL of the updateable replica, which is used by the multimaster replication protocol to issue referrals.

An RUV is information that describes how up-to-date one replica is with respect to all other replicas. A replica is a locally-held copy of a portion of a DIT. The RUV includes a CSN for each known replica and describes the latest update received from that replica. The CSN is a combination of four numbers used to determine the correct ordering of update operations. The RUV is consulted when one replica sends a change to another, in order to determine the smallest set of updates needed to be sent to bring the replica up-to-date.

The RUV is a member of a replica object, which a replication plugin uses for an in-memory representation of information related to the replica. All access to the RUV is through an application programming interface (API) provided for the replica object. The replica object is initialized from a stable storage at server startup and the contents are written back to the stable storage periodically and during server shutdown. Replicas that do not represent overlapped areas of the DIT may be hosted on the server. The replica objects associated with these replicas are maintained in memory by using a replica list.

A client update of a server may occur at any one of the servers, eventually needing to be replayed on all other replicas. Each server maintains a list of updates that have been applied to the local copy of the DIT. When one server receives updates from another server, the amount of data transferred may be reduced by sending only the updates that the receiving server has not already received. RUV's encode the information regarding the updates that have been received by each replica. RUV's are then exchanged by the servers at the beginning of a replication session to convey information regarding the updates which are known to the replicas. If the information contained in the exchanged RUV has already been received by the replica, the corresponding update is not made.

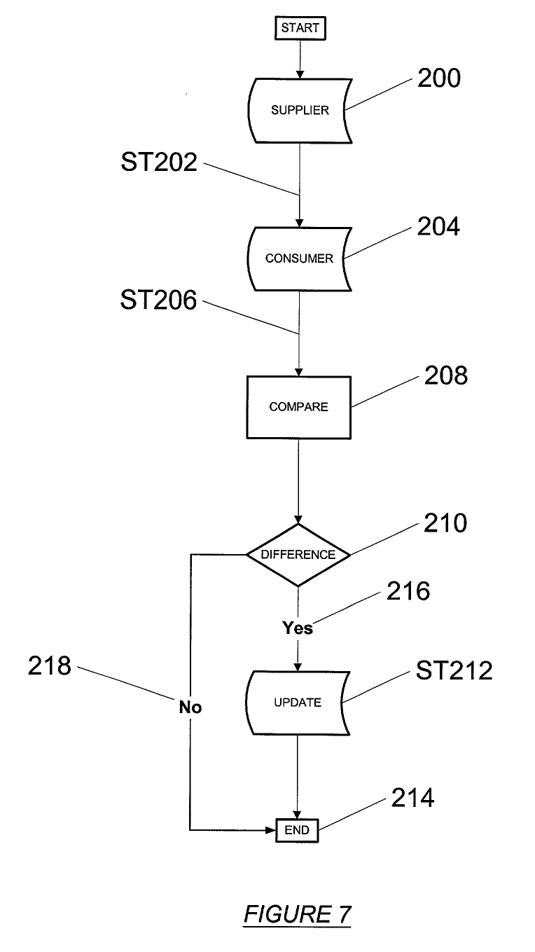

FIG. 7 illustrates an exemplary flow process of a replication session. A supplier server (200) requests the RUV information (step 202) from a consumer server (204). The consumer server (204) sends the RUV information (step 206) to the supplier server (200) where a comparison of the RUV's (208) is made to determine if a difference (210) exists. If there is a difference (216), the supplier sends the differences as an update to the consumer's RUV (step 212) and then ends the session (214). If there is no difference (218), the replication session ends the session (214) without updating.

An RUV is persistently stored in the DIT together with the data to which the RUV applies, therefore emphasizing that the RUV is a property of the data and is created and destroyed with the data. For example, the RUV is stored in a entry in a subtree of the DIT in a nsds50ruv attribute. The entry is given a uniqueid of “ff-ffffffff-ffffffff-ffffffff-ffffffff.” The nsds50ruv attribute includes one or more of the following: a value that holds a generation ID for data, and a series of zero or more attributes that include the CSN's and a partial URL for the replica. An example of the nsds50ruv attribute is as follows:

nsds50ruv: {replicageneration} <generation-id-for-this-replica>
nsds50ruv: {replica [<url>]} <mincsn> <maxcsn>
nsds50ruv: {replica[<url>]} <mincsn> <maxcsn>
...
nsds50ruv: {replica [<url>]} <mincsn> <maxcsn>
Where:
<generation-id-for-this-replica> is the generation ID for this replica
<url> is an LDAP URL that tells the host name and port number of the
replica
<mincsn> is the smallest CSN known to have been generated by that
replica
<maxcsn> is the largest CSN seen from that replica
For example:
dn: nsuniqueid=ff-ffffffff-ffffffff-ffffffff-ffffffff, o=Airius.com
nsuniqueid: ff-ffffffff-ffffffff-ffffffff-ffffffff
nsds50ruv: {replicageneration} 38flae3000000010000
nsds50ruv: {replica ldap://earth.red.iplanet.com:389}

38fdlb42000000010000 38fdddb3000000010000

nsds50ruv: {replica ldap://earth.red.iplanet.com:389}

38fd1c0b000000020000 38fdedb5000000010000

This RUV describes a replica that has a generation ID of 38flae3000000010000, and two known replicas.

In memory, representation of an RUV contains, for each master (updateable replica), the structure called a CSN pending list. The CSN pending list is used to keep track of the CSN's of updates that have been received, but not yet fully processed, in order to ensure that a maximum CSN is correctly updated. For example, there may be two updates in progress, a first update with CSN equal to four, and a second update with CSN equal to five. While both updates may have been received in monotonically increasing order, due to concurrency, the first and second updates may be processed out of order. As a result, a related maximum CSN may equal five before the update with an associated CSN equal to four is processed, therefore resulting in incorrect server behavior. With the use of the CSN pending list, the replica will notice that the update with CSN equal to four has not been fully processed and will delay maximum CSN update until processing of the update with CSN equal to four is complete.

The RUV information is available by obtaining the replica object from the replica list maintained by the server, and then calling an API function that deals with the RUV information. The RUV may call one or more API functions, including but not limited to a function to obtain the replica object, a function to iterate the list of replica objects, a function to add new replica objects to the replica list, and a function to initialize the in-memory replica object.

Advantages of the present invention may include one or more of the following. The RUV allows changes to multiple servers to be done quickly, reducing processing time and consumption. Another advantage is that the RUV is stored in stable storage to prevent information that may be lost due to server reboots and crashes. Those skilled in the art will appreciate that the present invention may have further advantages.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A directory server comprising:
a supplier server;
a consumer server in communication with the supplier server;
a plurality of pluggable services that manage replication of data contained within the directory server from the supplier server to the consumer server; and
a replica update vector used to determine a minimal set of updates necessary to synchronize the consumer server with respect to the supplier server;
wherein replication of data is managed using the replica update vector.

2. The directory server of claim 1, wherein the replica update vector is persistently stored in a directory information tree.

3. The directory server of claim 1, wherein a memory representation of the replica update vector comprises a change sequence number pending list.

4. The directory server of claim 1, wherein the replica update vector comprises a change sequence number for each known replica and a description of a latest update received from a corresponding replica.

5. The directory server of claim 1, wherein the replica update vector is accessed through an application programming interface.

6. A method of updating a replica update vector, comprising:
requesting a replica update vector from a consumer server;
sending the replica update vector from the consumer server to a supplier server;
comparing the replicate update vector of the consumer server with the replica update vector of the supplier server; and
sending discrepancies of a comparison from the supplier server as an update to the replica update vector of the consumer server, if a discrepancy exists.

7. The method of claim 6, further comprising, exchanging the replica update vector at the beginning of a replication session.

8. The method of claim 6, wherein the replica update vector is persistently stored in a directory information tree.

9. The method of claim 6, wherein a memory representation of the replica update vector comprises a change sequence number pending list.

10. The method of claim 6, wherein the replica update vector comprises a change sequence number for each known replica and a description of a latest update received from a corresponding replica.

11. The method of claim 6, wherein the replica update vector is accessed through an application programming interface.

12. A method of updating a replica update vector, comprising:
requesting a replica update vector from a consumer server;
sending the replica update vector from the consumer server to a supplier server;
comparing the replica update vector of the consumer server with the replica update vector of the supplier server;
sending discrepancies of a comparison from the supplier server as an update to the replica update vector of the consumer server, if a discrepancy exists; and
exchanging the replica update vector at the beginning of a replication session.

13. An apparatus for updating a replica update vector, comprising:
means for requesting a replica update vector from a consumer server;
means for sending the replica update vector from the consumer server to a supplier server;
means for comparing the replica update vector of the consumer server with the replica update vector of the supplier server; and
means for sending discrepancies of a comparison from the supplier server as an update to the replica update vector of the consumer server, if a discrepancy exists.
